(19) United States
(12) Patent Application Publication
(10) Pub. No.: US 2025/0136518 A1
(43) Pub. Date: May 1, 2025

(54) SHAPE MEMORY CERAMICS AND MANUFACTURING AND 4D PRINTING METHODS THEREOF

(71) Applicant: City University of Hong Kong, Hong Kong (HK)

(72) Inventors: Jian LU, Hong Kong (HK); Guo LIU, Hong Kong (HK)

(21) Appl. No.: 18/749,667

(22) Filed: Jun. 21, 2024

Related U.S. Application Data
(60) Provisional application No. 63/509,284, filed on Jun. 21, 2023.

(51) Int. Cl. C04B 35/56; B28B 1/00; B33Y 10/00; B33Y 70/10; B33Y 80/00; C04B 35/626; C04B 41/00; C04B 41/53

(52) U.S. Cl. CPC C04B 35/5603; B28B 1/001; B28B 1/008; B33Y 10/00; B33Y 70/10; B33Y 80/00; C04B 35/6267; C04B 41/0045; C04B 41/53; C04B 2235/483

(57) ABSTRACT

A shape memory ceramic is provided. The shape memory ceramic comprises a first portion and a second portion. The first and second portions of the shape memory ceramic are bonded, and the shape memory ceramic is elastomer-derived ceramic comprising silicon oxycarbide. The first portion of the shape memory ceramic is treated with ultraviolet ozone, and the second portion of the shape memory ceramic is free from treatment of ultraviolet ozone. The manufacturing and 4D printing methods of the shape memory ceramic are also provided.

### CROSS-REFERENCE TO RELATED APPLICATIONS

The present application claims priority from U.S. Provisional Patent Application No. 63/509,284 filed Jun. 21, 2023; the disclosure of which is incorporated herein by reference in its entirety.

### FIELD OF THE INVENTION

The present invention generally relates to shape memory ceramics (SMCs) and the manufacturing techniques thereof. More particular, the present invention relates to shape memory ceramics made with four-dimensional (4D) additive-subtractive manufacturing technologies.

### BACKGROUND OF THE INVENTION

Unlike shape memory alloys (SMAs), the shape memory ceramics (SMCs) are a class of materials with the unique ability to recover their original shape after deformation when subjected to certain stimuli, such as temperature changes. These ceramics exhibit shape memory effects due to their ability to undergo reversible phase transformations between different crystal structures. Unlike SMAs, which are more commonly known, SMCs offer advantages such as high-temperature stability, corrosion resistance, and biocompatibility. These materials hold significant promise for various applications in aerospace, biomedical devices, actuators, and adaptive structures, where precise shape control and reliable performance are critical. However, manufacturing SMCs with complex curved structures poses significant challenges due to the intricate processing techniques required and the inherent brittleness of ceramic materials. Achieving precise control over the shape memory properties of ceramics, particularly in curved geometries, remains a major hurdle in the development and widespread adoption of these materials.

The world of additive manufacturing (AM) for building structural materials is buzzing with research. Currently, three-dimensional (3D) printing systems, a type of AM system, are speedy and scalable, but there is a catch. They often have to sacrifice resolution for speed or scalability. Luckily, a solution is on the horizon: combining AM with subtractive manufacturing (SM) to create additive-subtractive manufacturing (ASM). This concept could revolutionize 3D printing by offering rapid, precise, and scalable technology.

However, progress in 3D printing has been stymied by the high melting points of some materials. On a brighter note, inspiration from origami and kirigami techniques has propelled advancements in four-dimensional (4D) printing.

4D printing, an emerging technology, adds an additional dimension of time to traditional 3D printing by enabling materials to transform their shape or properties over time in response to external stimuli. This innovative approach holds immense potential for creating dynamic and adaptive structures that can self-assemble, self-repair, or undergo shape changes on demand. 4D printing typically involves the use of smart materials, such as shape memory polymers or hydrogels, which can be programmed to respond to stimuli such as heat, light, or moisture. While still in its early stages, 4D printing has already demonstrated applications in fields such as architecture, robotics, medicine, and aerospace, offering solutions for complex manufacturing challenges and enabling new functionalities that were previously unattainable.

Combining SMCs with 4D printing techniques presents exciting opportunities for developing advanced materials and structures with dynamic shape-changing capabilities and high-temperature resilience. However, mass production of SMCs with complex curved structures poses significant hurdles. Traditional manufacturing methods such as sintering or hot pressing are often limited in their ability to produce intricate shapes efficiently and consistently. Additive manufacturing techniques, including 3D printing, offer potential solutions for overcoming these challenges by enabling precise control over material deposition and layer-by-layer construction. Nevertheless, scaling up production to meet commercial demands while ensuring quality control and cost-effectiveness remains a key challenge that must be addressed to unlock the full potential of SMCs in diverse applications.

### SUMMARY OF THE INVENTION

The present invention addresses the aforesaid shortcomings and provides significant improvements over traditional SMCs and the methods of manufacturing thereof, and the successful attempt at original/reverse and global/local multimode shape memory behaviors of ceramics opens the way to various types of self-morphing of SMCs.

The present invention relates to the martensitic phase transformation and provides a novel mechanism for SMCs. Various embodiments of the present invention provide SMCs with heterogeneity in the thermal expansion-shrinkage behavior. In some embodiments of the present invention, versatile SiOC-based SMCs are developed in a facile manner by the physical mixing of liquid silicone with varying ceramic fillers. Geometrical flexibility could be largely enhanced with 4D ASM.

Furthermore, the present invention extends the dimensions of structural SMCs from the microscale/mesoscale to the macroscale and achieved original/reverse and global/local multimode shape memory capabilities of ceramics.

In accordance with a first aspect of the present invention, a SMC is provided. The SMC comprises a first portion and a second portion. The first and second portions of the SMC are bonded. The SMC is elastomer-derived ceramic comprising silicon oxycarbide. The first portion of the SMC is treated with ultraviolet ozone (UV/ozone), and the second portion of the SMC is free from treatment of UV/ozone.

In accordance with one embodiment of the present invention, the second portion of the SMC has a plurality of grooves.

In accordance with another embodiment of the present invention, the first portion of the SMC form a plurality of strips on a surface of the second portion of the SMC.

In accordance with a second aspect of the present invention, a manufacturing method of SMC is provided. The manufacturing method comprises: providing a structural precursor comprising polydimethylsiloxane (PDMS); treating a portion of a surface of the structural precursor with UV/ozone; and processing the structural precursor using pyrolysis, so as to generate the SMC.

In accordance with one embodiment, the step of providing the structural precursor comprises: forming a first precursor using additive manufacturing; and cutting or engraving the first precursor using laser to form the structural precursor.

In accordance with another embodiment, the additive manufacturing comprises blade coating or direct ink writing.

The step of treating with UV/ozone comprises: masking a surface of the structure precursor with a laser-cut paper; and treating the masked surface with UV/ozone.

In accordance with one embodiment, after the pyrolysis process, the manufacturing method further comprises: heating the SMC in air.

In accordance with another embodiment, after the pyrolysis process, the manufacturing method further comprises: heating a portion of the SMC in air.

In accordance with yet another embodiment, after the pyrolysis process, the manufacturing method further comprises: heating at least a portion of the SMC in air using induction heating.

In accordance with various embodiments of the present invention, the aforementioned steps are performed in a turntable system with multiple stations.

In accordance with various embodiments of the present invention, the structural precursor further comprises ceramic particles (fillers) or glass particles (fillers).

In some embodiments of the present invention, the SMC has a portion that is treated with UV/ozone, and different parts of the SMC can have different material properties including thermal expansion and shrinkage, so as to utilize in 4D printing with high efficiency.

The present invention introduces a completely new fabrication mechanism for silicone matrix composites, that is, utilizing the heterogeneity in the thermal expansion-shrinkage behavior. Based on the newly developed SMC fabrication mechanism (heterogeneity in thermal expansion-shrinkage behavior), versatile SiOC-based SMCs can be developed in a facile manner by the physical mixing of liquid silicone with varying ceramic fillers.

In some embodiments of the present invention, geometrical flexibility is significantly enhanced with 4D ASM, that is, 2D/3D printing combined with laser engraving/cutting of ceramic precursors, when compared to the ceramic powder pressing methods used in previous studies. Additionally, the dimensions of structural SMCs are extended from the microscale/mesoscale to the macroscale, achieving both original/reverse and global/local multimode shape memory capabilities in ceramics. The advancements differentiate the present invention from existing studies on SMCs.

### BRIEF DESCRIPTION OF THE DRAWINGS

Embodiments of the invention are described in more details hereinafter with reference to the drawings, in which:

FIG. 1 is a schematic view of a structural precursor having a plurality of grooves and built with elastomer material including PDMS through additive manufacture or subtractive manufacture in accordance with one embodiment of the present invention;

FIG. 2 is another schematic view of the structural precursor with a portion thereof treated with UV/ozone in accordance with this embodiment;

FIG. 3 is a schematic view of a SMC processed with pyrolysis in accordance with this embodiment;

FIG. 4 is a schematic view of a structural precursor applied with mask in accordance with another embodiment of the present invention;

FIG. 5 is another schematic view of the structural precursor with a portion thereof treated with UV/ozone in accordance with this embodiment;

FIG. 6 is a schematic view of a SMC processed with pyrolysis in accordance with this embodiment;

FIG. 7 is an illustration of the engineering of heterogeneous precursors and 4D ASM of SMCs in accordance with an embodiment of the present invention;

FIG. 8 is a schematic view of a plurality of structural precursors having groove depths of 100-500 μm for 4D printing in accordance with this embodiment;

FIG. 9 shows a series of images of the shape and material transformations during heating treatment of ceramic precursor structures generated using the methods as illustrated in FIG. 7;

FIG. 10 shows the finite element method (FEA) simulation results of the influence of thermal expansion on bending deformation of the ceramic precursor structures as shown in FIG. 9;

FIGS. 11A, 11B, and 11C are the scanning electron microscope (SEM) images of first-generation elastomer-derived ceramics (EDCs) derived from precursors induction-heat-treated at 1,300° C. as shown in FIG. 9;

FIGS. 12A and 12B are charts showing the porosity of the first-generation EDCs;

FIG. 13 depicts a series of images of the shape and material transformations of a first-generation EDC derived from the structural precursor having grooves whose depths are 200 μm during heating treatment, resulting in a second-generation EDC in accordance with an embodiment of the present invention;

FIG. 14 depicts a series of images of the shape and material transformations of a first-generation EDC derived from the structural precursor having grooves whose depths are 500 μm during heating treatment, resulting in a second-generation EDC in accordance with an embodiment of the present invention;

FIG. 15 depicts a series of images of the shape and material transformations of a first-generation EDC derived from the structural precursor having grooves whose depths are 100 μm during heating treatment, resulting in a second-generation EDC in accordance with an embodiment of the present invention;

FIG. 16 is a chart showing the influence of the precursor groove depths on the curvatures of the resulting first- and second-generation EDCs with reverse shape memory capability;

FIG. 17 is a chart showing X-ray diffraction analysis patterns of the first- and second-generation EDCs;

FIG. 18 depicts an illustration of a manufacturing method of second-generation EDCs or first/second-generation composite EDCs in accordance with one embodiment of the present invention;

FIG. 19 depicts an illustration of 3D printing and local surface treatment offering potential for enhancing geometrical complexity in 3D structuring and 4D shaping in accordance with one embodiment of the present invention;

FIG. 20 depicts a further illustration of the 3D printing and local surface treatment in an exemplary application of the present invention, featuring 4D printed first-generation EDCs resulted from heterogeneous structural precursors generated according to an embodiment of the present invention;

FIG. 21 a series of images of the shape and material transformations during the heating treatment of the heterogeneous precursors in the exemplary application;

FIG. 22A shows a 3D scan image of a 4D printed all-ceramic blisk in another exemplary application of the present invention; and FIG. 22B shows a color mapping analysis of the 3D scan image of the 4D printed all-ceramic blisk;

FIGS. 23A and 23B show the mechanical and thermal characterization of the PDMS/20 wt % ZrO₂ in precursors in some embodiments of the present invention under an experiment; with FIG. 23A showing the tension behaviors, and the inset showing the region of 0%-10% strain in the loading process to achieve the corresponding Young's modulus; and FIG. 23B showing the thermal expansion behaviors of the PDMS/20 wt % ZrO₂ at temperatures below 445° C.;

FIGS. 24A and 24B show the thickness and Young's modulus of the UV/ozone film on the heterogeneous structural precursors as shown in FIG. 20; with FIG. 24A showing the SEM image; and FIG. 24B showing the Nanoindentation test;

FIG. 25 shows FEA simulation results for the thermal expansion process of the heterogeneous structural precursors as shown in FIG. 21;

FIG. 26 shows the second-generation EDCs resulted from the first-generation EDCs of a 4D printed all-ceramic blisk in an exemplary application of the present invention;

FIGS. 27A and 27B show two series of images of the shape and material transformations under heating treatments of the first-generation EDCs derived from heterogeneous structural precursors for the 4D printed all-ceramic blisk, resulting in second-generation EDCs;

FIG. 28 depicts an illustration of the blade coating and laser machining in accordance to an embodiment of the present invention, offering the potential for enhancing manufacturing speed and precision;

FIG. 29 depicts an illustration of the mass production capability of heterogeneous precursor materials assisted by a multistation turntable system in an embodiment of the present invention;

FIG. 30 depicts an illustration of the mass production of a 10×10 array of ceramic kirigami structures generated using the blade coating and laser machining illustrated in FIG. 28 and the repeatability in 10 demonstrations of 4D printed flower-type ceramic structures;

FIG. 31 depicts an illustration of space exploration application of the 4D ASM of SMCs in accordance with an embodiment of the present invention; and

FIG. 32 illustrates the balance between thermal expansion and shrinkage effects serving as one of the key mechanisms for 4D printing.

### DETAILED DESCRIPTION

In the following description, SMCs, manufacturing methods and 4D printing thereof are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Color drawings are submitted with the Specification. The color drawings are necessary as the only practical medium by which aspects of the claimed subject matter may be accurately conveyed. Color drawings are the only practical medium by which to disclose the subject matter sought to be patented because the claims relate to SMC enduring heating process with controlled temperatures, where using different colors is the only feasible method to show the different temperatures on different parts or regions of the structures of the claimed subject matters.

In accordance with one aspect of the present invention, SMCs are provided. In accordance with another aspect of the present invention, the manufacturing methods of the SMCs are provided.

In one embodiment, the SMC is made of elastomer-derived ceramic (EDC), and the elastomer is processed with UV/ozone treatment before pyrolysis.

In this embodiment, before pyrolysis, a ceramic precursor is provided. The ceramic precursor comprises polydimethylsiloxane (poly(dimethylsiloxane) or PDMS), and UV/ozone treatment is applied to portion of the ceramic precursor. UV/ozone treatment is a process that involves exposing the ceramic precursor to ultraviolet (UV) light in the presence of ozone gas.

After treatment, a heterogeneous ceramic precursor is provided in the embodiment, and a treated portion of heterogeneous ceramic precursor has a coefficient of thermal expansion or a different thermal shrinkage ration that is different from the rest or remaining portion of the heterogeneous ceramic precursor. After pyrolysis, a SMC is provided, and the shape of the SMC can be modified during the pyrolysis and the following heating treatment.

In some embodiments, the ceramic precursor comprises polysiloxane (silicone oil), polyborosiloxane (PBS), polycarbosiloxane, polysilazane, apolysilazane, poly(organosilylcarbodiimide), apoly(organosilylcarbodiimide), hydrogel, or combination thereof.

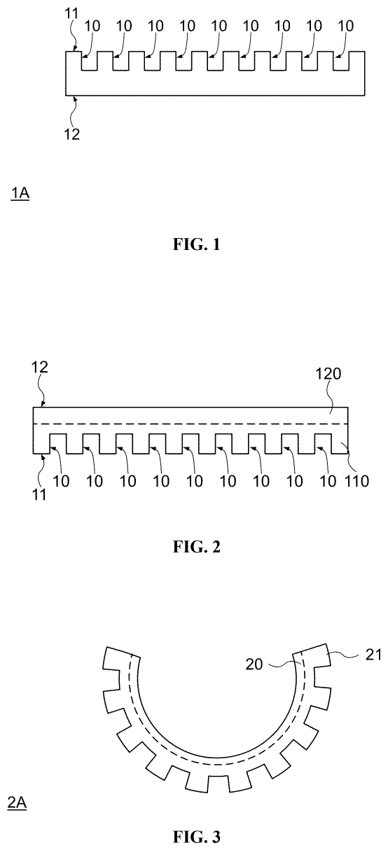

Referring to FIGS. 1-3 for the following description. In accordance with one embodiment of the present invention, the structural precursor 1A provided in this step has a plurality of grooves 10 as shown in FIG. 1. More specifically, the structural precursor 1 of this embodiment is substantially a flat structure with two wide surfaces 11 and 12, and all the grooves 10 are formed on one of the surfaces, i.e., surface 11, while the other surface, i.e., surface 12, remains flat.

In this embodiment, the structural precursor 1 is built with elastomer material including PDMS, and the structural precursor 1 is constructed with a unique structural design, incorporating specific features that delineate the areas intended for further shape modification in the following SMC conversion.

In this embodiment, the depths of the grooves 10 are 100 km. In some other embodiments, the depths of the grooves 10 can be 200 m or 500 km. Therefore, the structural precursor 1A can be easily acquired through a subtractive manufacturing such as laser engraving.

FIG. 2 is another schematic view of the structural precursor of this embodiment. As shown in FIG. 2, after the structural precursor 1A is provided, the manufacturing method of this embodiment treats a portion 120 of the surface (i.e., surface 12) of the structural precursor with UV/ozone. The surface 12 of the structural precursor, as well as the adjacent portion 120, is fully treated with UV/ozone.

In other words, in this embodiment, after the UV/ozone treatment, a thin film was formed on the surface 12 of the structural precursor 1A, with the film thickness adjusted by varying the processing time in an UV/ozone system.

In this step, a structural precursor demonstrating heterogeneity in the thermal expansion-shrinkage behavior across different portion is provided, and the heterogeneity led to shape transformation in the following steps. In other words, a ceramic precursor exhibiting variation in thermal expansion and shrinkage behavior across different regions is provided in this step, and it causes shape transformation in the following steps of SMC manufacturing.

More specifically, while the portion 120 of the structural precursor is treated with UV/ozone, the portion 110 of the structural precursor is shielded from the UV/ozone treatment. The portion 110 and the portion 120 are bonded, and the portion 110 has the grooves 10. The thermal expansion and shrinkage behavior of the portion 110 is different from the thermal expansion and shrinkage behavior of the portion 120.

After the UV/ozone treatment, the manufacturing method of this embodiment processes the structural precursor using pyrolysis, so as to generate a SMC 2A as shown in FIG. 3. The UV/ozone treatment indicates the use of UV light and ozone in a combined treatment process, and both the components are applied simultaneously or in a coordinated manner. Pyrolysis in this embodiment is a chemical process in which a ceramic precursor is heated to high temperatures in the absence of oxygen or with limited oxygen supply, i.e., inert atmosphere such as argon. During pyrolysis, the polymer of the structural precursor decomposes, leaving behind a ceramic residue.

In other words, the step involves a polymer-to-ceramic conversion stage, forming the SMC 2A. However, the present invention is not limited to the shape and curvature of the SMC 2A.

The SMC 2A comprises a portion 20 and a portion 21. The portion 20 and the portion 21 of the SMC 2A are bonded, and the SMC 2A is elastomer-derived ceramic comprising silicon oxycarbide.

In the steps above, the portion 20 of the SMC 2A is treated with UV/ozone, and the portion 21 of the SMC is free from treatment of UV/ozone. Therefore, the pyrolysis induced a shape transformation and formed the SMC 2A, and a 4D printing is performed.

Furthermore, the shape of the SMC 2A can be further modified with heating processing in air atmosphere. As the portion 20 and the portion 21 still possess different thermal expansion and shrinkage behavior, by performing further heating process in air atmosphere, the shape of the SMC 2A can be further modified.

In other words, after the pyrolysis, the SMC 2A is a first-generation EDC with modified shape. For further modification in its shape, at least a part of the SMC 2A can be heated in air. During the heating process, the part of the SMC 2A being heated performs a shape transformation, resulting in a second-generation EDC after the heating process.

In some embodiments, the manufacturing method further comprises heating the whole SMC in air in order to modify the shape of the SMC in every part, and the whole SMC is transformed to a second-generation EDC.

In some other embodiments, the manufacturing method further comprises heating a portion of the SMC in air in order to modify the shape of only certain parts of the SMC, and those parts of the SMC are transformed to second-generation EDCs.

In some other embodiments, the manufacturing method further comprises heating at least a portion of the SMC in air using i.e., a flame gun. The step can transform parts of the SMC or the whole SMC into second-generation EDC in order to perform a shape modification.

Therefore, the SMC 2A is well-suited for shape modification after the additive manufacture and subtractive manufacture are performed.

In accordance with one embodiment of the present invention, a 4D printing method is provided. Here, the portion 21 of the SMC 2A has a plurality of grooves. Due to the shape design of the portion 21 and the difference of the thermal expansion and shrinkage behavior, the SMC 2A is bent after the pyrolysis, and it can be bent again by a heating process.

The step of providing the structural precursor 1A comprises: forming a first precursor using additive manufacturing; and cutting or engraving the first precursor using laser to form the structural precursor.

In one embodiment, the additive manufacturing comprises blade coating, which involves running a blade over a substrate to spread a solution evenly across its surface, and it's a proper two-dimensional additive manufacturing with high efficiency.

In another embodiment, the additive manufacturing comprises direct ink writing (DIW), which involves the extrusion of a viscous ink or paste through a fine nozzle onto a substrate or build platform. DIW allows for precise control over the deposition of materials, enabling the fabrication of complex, customized object with tailored properties.

In yet another embodiment, the additive manufacturing comprises material jetting, photopolymerization, powder bed fusion or combination thereof.

In the step of forming the first precursor, the material of the additive manufacturing includes PDMS, which is a proper material for a ceramic precursor.

In some embodiments, the material of the additive manufacturing includes: polysiloxane, polyborosiloxane, polycarbosiloxane, polysilazane, poly(organosilylcarbodiimide), hydrogels, and combinations thereof.

In the step of forming the first precursor, the material of the additive manufacturing further includes zirconium dioxide nanoparticles. For example, the concentration of the zirconium dioxide nanoparticles in the material can be 10 weight percent. In some other embodiments, the concentration of the zirconium dioxide nanoparticles in the material is 20 weight percent. Therefore, the SMCs and the manufacturing method thereof can provide Zirconia-based ceramics, which have high temperature stability, high mechanical strength and toughness, chemical inertness, and biocompatibility. The zirconium dioxide nanoparticles are added to the liquid PDMS and mixed using a triple roller mill. The mixed material may be centrifuged after loading to a syringe.

In some other embodiments, the material of the additive manufacturing further includes aluminum oxynitride nanoparticles. For example, the concentration of the aluminum oxynitride nanoparticles in the material can be 50 weight percent. Therefore, the SMCs and the manufacturing method thereof can provide ceramic with enhanced hardness, transparency, thermal stability, and chemical inertness.

In some other embodiments, the material of the additive manufacturing further includes ceramic particles or glass particles, and the structural precursor comprises ceramic particles (fillers) or glass particles (fillers). Therefore, the SMC and the manufacturing method thereof can provide ceramic with different properties.

In some other embodiments, the material of the additive manufacturing further includes alumina, titania, silicon nitride, calcium oxide, silicon carbide, yttria, or aluminum nitride particles or nanoparticles.

The step of cutting or engraving the first precursor using laser provides a subtractive manufacturing with high precision. In one embodiment, silicone-based composite precursors are developed to achieve improved geometrical flexibility, and two-dimensional (2D) additive manufacturing such as blade coating or DIW is applied to generate elastomeric ceramic precursors. Meanwhile, subtractive manufacturing techniques with a high-energy beam (e.g., a laser beam) can enhance manufacturing precision, resulting in a high-resolution ASM system.

In some other embodiments, the step of cutting or engraving the first precursor may be performed with electron beam, high pressure liquids, or other controlled high energy flow.

The width of the grooves 10 in the structural precursor 1A can properly modifies the expansion and shrinkage of the ceramic in the following steps. For example, the width of the grooves 10 is 1 mm, while the depths can range from 100 μm to 500 μm. These grooves 10 can be precisely formed with the subtractive manufacturing using laser, and they can modify the expansion and shrinkage of the ceramic precisely.

In the step of UV/ozone treatment, the portion 120 is processed with UV/ozone treatment for 8 hours. Therefore, the portion 120 of can be properly formed. In the step of pyrolysis, the structural precursor is heated to 1,300° C. within 12 minutes in an induction heating furnace with an argon flow of 200 mm every minute, and the high temperature is maintained for 10 minutes. In the further step after pyrolysis, in some embodiments, the SMC is heated to 1,300° C. for 30 minutes in air with a tube furnace, so as to provide a SMC made of second-generation EDC.

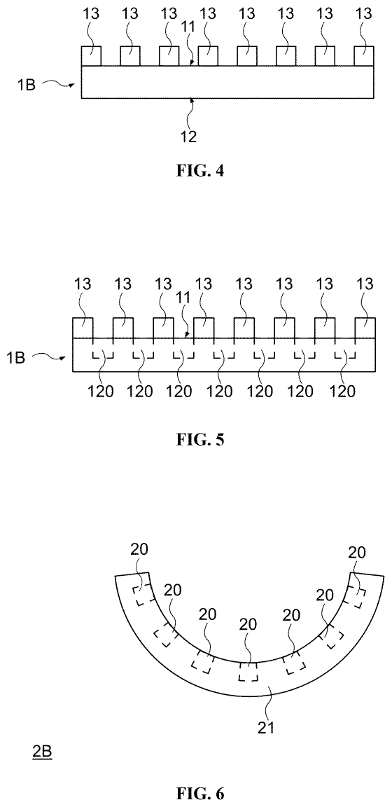

Referring to FIGS. 4-6 for the following description. In another embodiment of the present invention, the step of UV/ozone treatment comprises: masking the surface 11 of the structural precursor 1B with a laser-cut paper 13; and treating the masked surface 11 with UV/ozone. The laser-cut paper 13 can provide a masking with high precision on the surface 11, so as to expose parts of the surface 11 that is going to be treat with UV/ozone.

In this embodiment, the structural precursor 1B can be manufactured through 3D printing such as DIW, and the material includes PDMS and zirconium dioxide. For example, the concentration of the zirconium dioxide can be 20 weight percentage. In another example, the structural precursor 1B can be a blisk, a component comprising both rotor disk and blades as a single part, and FIG. 4 shows a blade portion of the blisk in pre-production. With the masking of laser-cut paper 13, the portions 120 are processed with UV/ozone treatment, and the location and dimensions of the portions 120 can be design with high precision using the laser-cut paper 13.

In this UV/ozone treatment step, precising masking is required to protect certain areas of the structural precursor 1B from exposure to UV light and ozone. The laser-cut paper 13 provide an effective solution as a mask. The laser-cut paper 13 is created by using laser cutting technology to precisely cut intricate patterns or shapes into paper sheets, and ensuring accurate masking of specific areas on the structural precursor 1B.

For example, the structural precursor 1B is planar and intersects the ground at 57°, and the structural precursor 1B is selectively exposed to UV/ozone treatment for 16 hours by masking the surface 11 with the laser-cut paper 13.

The structural precursor 1B as shown in FIG. 5 is processed using pyrolysis, so as to generate the SMC 2B as shown in FIG. 6. However, the present invention is not limited to the shape and curvature of the SMC 2B. The portions 20 and the portion 21 are bonded, and the portions 20 are treated with UV/ozone, thus, the SMC 2B can perform a shape transformation.

More specifically, during the pyrolysis, the structural precursor 1B undergoes controlled heating to 1,000° C. for 2 hours in a resistance heating furnace, followed by vacuum cooling to ambient temperature. The heating rate is maintained at 5° C. per minute and the cooling rate is 10° C. per minute.

After the cooling, a first-generation EDC is obtained. To obtain a second-generation EDC, the structural precursor 1B is subjected to additional heating. Initially, it is heated to 1,000° C., followed by further heating to 1,250° C. in an air atmosphere using a tube furnace.

In this embodiment, the SMC 2B is efficiently manufactured using 4D printing including the steps described above, and the usage of laser-cut paper 13 provide an easy-to-use, cost-effective, approach with compatibility. In an example, the structural precursor 1B as shown in FIG. 4 can be a blade portion of the blisk in pre-production, and the SMC 2B as shown in FIG. 6 can be the blade portion manufactured, which is well achieved by the usage of laser-cut paper 13.

Overall, using laser-cut paper masks in conjunction with UV/ozone treatment and pyrolysis offers several advantages, including precision masking, customizability, cost-effectiveness, ease of handling, compatibility with treatment processes, reduced residue, and scalability. These advantages contribute to improved process control, efficiency, and quality in the processing of components containing PDMS.

In some embodiments of the present invention, all of the steps of the manufacturing method are performed by a single manufacturing apparatus, which can be completely automated for resource and cost effectiveness. In some other embodiments, the steps of the manufacturing method of the embodiments above can be performed in a turntable system with multiple stations. More specifically, the stations can perform different complex processing including additive manufacturing, subtractive manufacturing, UV/ozone treatment, and/or other manufacturing techniques; and every step of the manufacturing method can be performed separately and in parallel manner in one of the stations. For example, one of the stations can perform additive manufacturing, and another one of the stations can perform subtractive manufacturing, and still another one can perform UV/ozone treatment, all simultaneously, achieving streamlined mass production. Therefore, the manufacturing method of the embodiments of the present invention can be utilized in mass production.

In some other embodiments of the present invention, a manufacturing method of a SMC can further comprise deposition process. The deposition process includes physical vapor deposition, chemical vapor deposition, atomic layer deposition or combination thereof. Therefore, the SMC provided in these embodiments may further comprised layers for protection or any required function.

The SMC provide in any of the embodiments above can be applied in morphing thermal protection systems or space origami systems. Also, the SMC can be applied in on-orbit manufacturing and repairing.

The following description explains in more details the SMCs, the manufacturing and 4D printing methods thereof in accordance with the various embodiments of the present invention from different perspectives.

In accordance with one embodiment of the present invention, silicone-based composite precursors are developed to achieve improved geometrical flexibility, then blade coating (two-dimensional (2D) additive manufacturing) or direct ink writing (DIW) (3D additive manufacturing) is applied to generate elastomeric ceramic precursors. Meanwhile, subtractive manufacturing techniques with a high-energy beam (e.g., a laser beam) is used to enhance manufacturing precision, resulting in a high-resolution ASM system. The 2D/3D additive manufacturing-applied elastomeric ceramic precursors then undergo laser engraving or cutting using an optimized laser scanning strategy, which involves the precise control over laser scanning power and speed. Subsequently, the treated precursors were subjected to heat treatment to transform them into structural ceramics.

4D printing of the ceramic materials has been developed by tuning heterogeneous precursors. By integrating the elastic precursor laser cutting/engraving (EPLC/EPLE) technique and the ceramic 4D printing technique, a complex-shaped, high-resolution, cost-efficient, and environmentally friendly 4D ASM paradigm for ceramic materials is developed by the present invention. This fully embodies the integration of modern advanced manufacturing technologies with ancient ceramic arts.

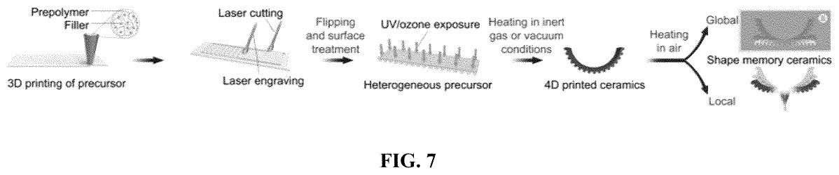

FIG. 7 illustrates a representative ceramic 4D printing strategy in accordance with the various embodiments of this invention. First, a high-resolution laser is used to tune the stiffness of the structures of the samples. Subsequently, a thin film was created on the surface of the samples by an UV/ozone system, and the film thickness was tuned by changing the processing time in the UV/ozone system. The samples are then subjected to heat treatment in inert gas or vacuum conditions. The thermal expansion and shrinkage behaviors of the UV/ozone treated material and 3D printed precursor material without treatment are different, and this heterogeneity leads to shape transformation of the precursor structures. In addition, owing to the different thermal shrinkage behaviors of the materials derived from the UV/ozone treated and untreated precursor materials, 4D printed first-generation EDCs can be further deformed by global or local heat treatment in air, resulting in second-generation or first/second-generation composite EDCs.

By the manufacturing methods according to the embodiments of the present invention, the grooves on a structural precursor can be designed precisely. As shown in FIG. 8, structural precursors 8A-8E have a UV/ozone film located at the top, and the UV/ozone films are treated by the UV/ozone treatment. Grooves are formed at the bottom of each structural precursor. The depth of the grooves in the structural precursor 8A is 100 μm; the depth of the grooves in the structural precursor 8B is 200 μm; the depth of the grooves in the structural precursor 8C is 300 μm; the depth of the grooves in the structural precursor 8D is 400 μm; and the depth of the grooves in the structural precursor 8E is 500 μm. These structural precursors 8A-8E are manufactured through ASM, and the material of these structural precursors includes PDMS and zirconium dioxide, whose concentration is 10 weight percentage. The grooves are formed through carbon dioxide laser machining equipment, and the width to each groove is 1 mm.

In some embodiments, rapid one-step shape/material transformation of the structural precursors is achieved using an induction heating furnace. The material and shape transformations of the engineered heterogeneous ceramic precursors could be simultaneously achieved in as fast as a few seconds with a heating rate of 1,000° C. min⁻¹, which is 100 times faster than the conventional resistance heating techniques. Induction heating is a highly efficient, energy-saving and environmentally friendly heating method with a wide range of applications such as metal melting, surface heat treatment and ceramic composite sintering. Induction heating converts electrical energy into thermal energy and has a high utilization rate of electrical energy, with a heating efficiency of over 90% and an energy consumption of only ⅓ of that of conventional heating.

As shown in FIG. 9, which shows shape and material transformations of the ceramic precursor structures having groove depths of 100-500 μm (as shown in FIG. 8), the structural precursors are heated to 1,300° C. in 12 minutes (with the structural precursors after 4 minutes and 33 seconds shown in FIG. 9B and the structural precursors after 12 minutes in FIG. 9C) in an induction heating furnace with an argon flow having a flow rate of 200 mL per minute. Subsequently, the temperature of the induction heating furnace environment is maintained at 1,300° C. for 10 minutes (with the structural precursors after 22 minutes shown in FIG. 8D). The results are first-generations EDCs.

In some embodiments, a smooth boron nitride (BN) plate is selected as the substrate because BN is well known for its excellent thermal stability and low-friction behavior. The BN substrate is also used to reduce the friction and sticking that could lead to forces being imparted on the object during shape deformation.

The precise groove designs can be achieved using the ASM in the manufacturing method. Such precise groove designs in turn ensure versatility in building complex structures with zero, negative, positive, and mixed Gaussian curvatures. Owing to the different thermal expansion and shrinkage behaviors of the heterogeneous structural precursors, the ceramic precursor was transformed in terms of both shape and material components when subjected to thermal treatment.

Thermogravimetric analysis and differential scanning calorimetry showed that the polymer-to-ceramic transformations are achieved at 300-900° C. The Young's moduli of the PDMS/10 wt % ZrO₂ and the UV/ozone microfilm are 1 and 13 MPa, respectively. The elastomer and the UV/ozone film have the average compositions of SiO_{1.23}C_{1.45}Zr_{0.05} and SiO_{3.13}C_{14.81}Zr_{0.01}, respectively. The difference between the thermal expansion behaviors of the elastomers and the UV/ozone film leads to bending deformation. Moreover, the bending stiffness of the ceramic precursors and the curvatures of the resultant ceramics can be precisely tuned by modifying the depth and width of the laser-engraved grooves.

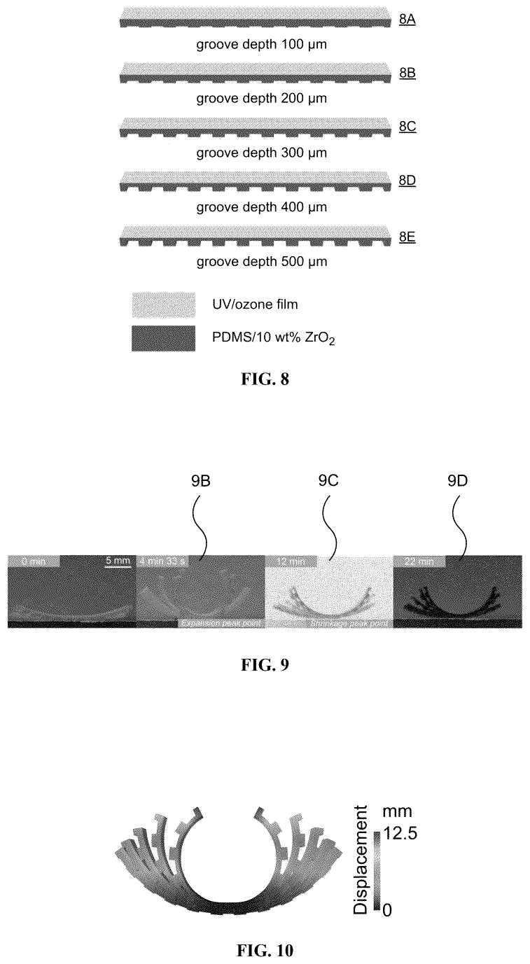

FIG. 10 shows the FEA simulations of the influence of thermal expansion on bending deformation, which are consistent with the shape and material transformations during heating process of the ceramic precursor structures as shown the images of FIG. 9. The precursors are transformed into ZrO₂—SiOC nanocrystalline-amorphous dual-phase (NCADP) ceramics with a porous feature or amorphous SiOC glass. FIG. 11 shows the SEM images of first-generation EDCs derived from the precursors induction-heat-treated at 1,300° C. as shown in FIG. 9; in which FIG. 11A shows the sample surface, and FIGS. 11B and 11C show the fracture surfaces.

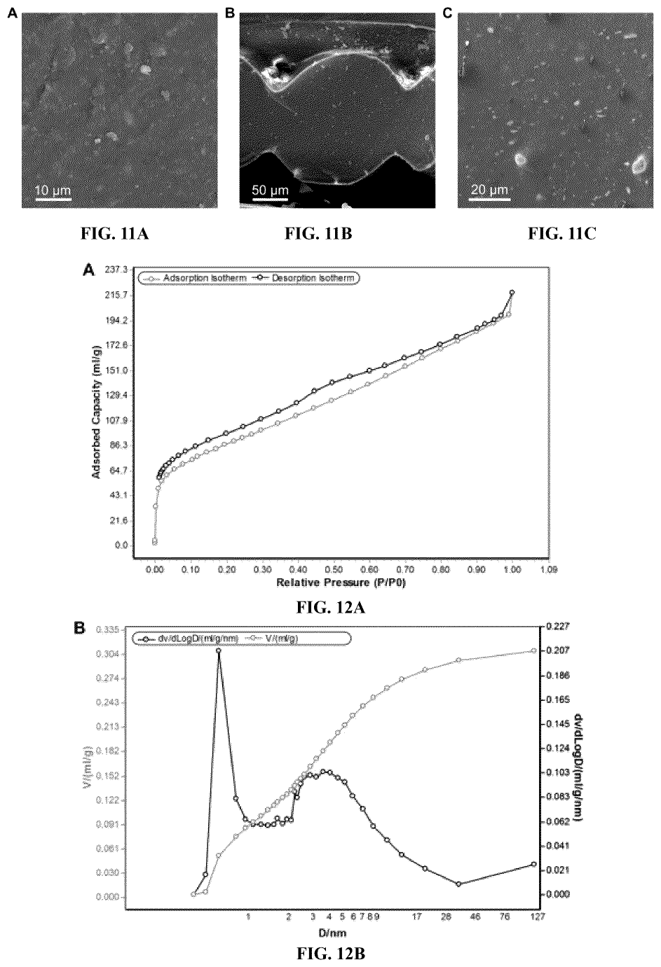

FIG. 12 shows the porosity of the first-generation EDCs derived from the precursors induction-heat-treated at 1,300° C. as shown in FIG. 9; in which FIG. 12A shows the N₂ adsorption/desorption isotherm of the ceramics, and the Brunauer-Emmett-Teller specific surface area is 310 m² g⁻¹, and FIG. 12B shows the cumulative pore volume and pore size distribution of the ceramics using nonlinear density functional theory analysis, and the cumulative pore volume (<128 nm) is 0.308 mL g⁻¹.

It can be demonstrated that the 4D printed ceramic structures are capable of secondary self-morphing and possess reversible reconfigurability. When the ceramic is heated in air, the heterogeneity remains in the thermal shrinkage behavior of the first-generation EDC derived from the heterogeneous precursor. For the first-generation EDCs derived from the homogeneous precursor material of PDMS/10 wt % ZrO₂ without UV/ozone treatment, the linear shrinkage ratios for heating in air at 1,000° C. and 1,200° C. were 3.5% and 5.6%, respectively.

The configurability of the corresponding first-generation EDCs derived from the heterogeneous precursors subjected to UV/ozone treatment can be tuned by heating in air under different conditions. In general, the higher the heating temperature (below the morphing end point) applied on the first-generation EDCs, the more recovery to their original shape in the resultant second-generation EDCs. If the morphing end point is above the original shape memory point, the first-generation EDCs bend in the opposite direction and exhibit reverse shape memory capability. The SMCs are reversibly reconfigurable to the original planar shapes of the precursors and even to the reverse curved shapes of the first-generation EDCs under appropriate heating conditions, resulting in second-generation EDCs and original/reverse multimode shape memory behaviors of ceramics. Similarly, local heat treatment in air, such as heating in the middle or on one side, provided flexibility for the local receramization and self-morphing of first-generation EDCs, generating first/second-generation composite EDCs with multiple shapes.

In some embodiments of the present invention, before the elastomer-to-ceramic transformation, the difference in the thermal expansion coefficients of the precursor materials affects the first-stage shape transformation. After the elastomer-to-ceramic transformation, the differences in the thermal shrinkage ratios of the precursor materials can further affect a second-stage shape transformation with notable material transformation. When the resultant first-generation EDCs are heated in air, the heterogeneity in the thermal shrinkage behavior of the first-generation EDCs resulted in original/reverse multimode shape memory behaviors and receramization into the second-generation EDCs.

In short, after the heating process, the structural precursors show different curvatures because of the difference in the depth of grooves, providing the first-generation EDCs of which their curvatures are properly controlled by the formation of the grooves. The first-generation EDCs can then be transformed into second-generation EDCs through further heating process. Although engineering the expansion and shrinkage of materials is a common strategy for 4D printing, this invention represents a successful attempt at 4D printing of ceramics by recording the balance between thermal expansion and thermal shrinkage.

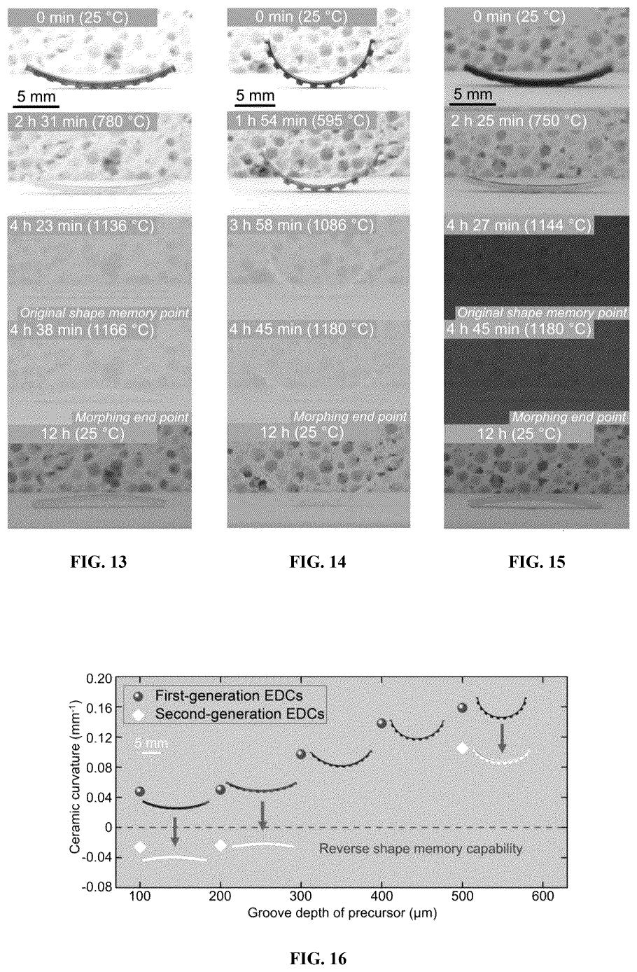

FIGS. 13-16 further demonstrate the afore-described embodiments. FIG. 13 depicts the images, at different points of time and temperatures during heating treatment, of a first-generation EDC derived from a structural precursor having grooves whose depths are 200 μm. The first-generation EDC as shown is heated to 1,300° C. for 30 minutes in air by a tube furnace, resulting in a second-generation EDC. FIG. 14 depicts the images, at different points of time and temperatures, of a first-generation EDC derived from a structural precursor having grooves whose depths are 500 μm during heating process. The first-generation EDC as shown is heated to 1,300° C. for 30 minutes in air by a tube furnace, resulting in a second-generation EDC. FIG. 15 depicts the images, at different points of time and temperatures, of a first-generation EDC derived from a structural precursor having grooves whose depths are 100 μm during heating process. The first-generation EDC as shown is heated to 1,300° C. for 30 minutes in air through the tube furnace, so as to provide the second-generation EDC. FIG. 16 summarizes the relationship between the precursor groove depths and the curvatures of the first- and second-generation EDCs.

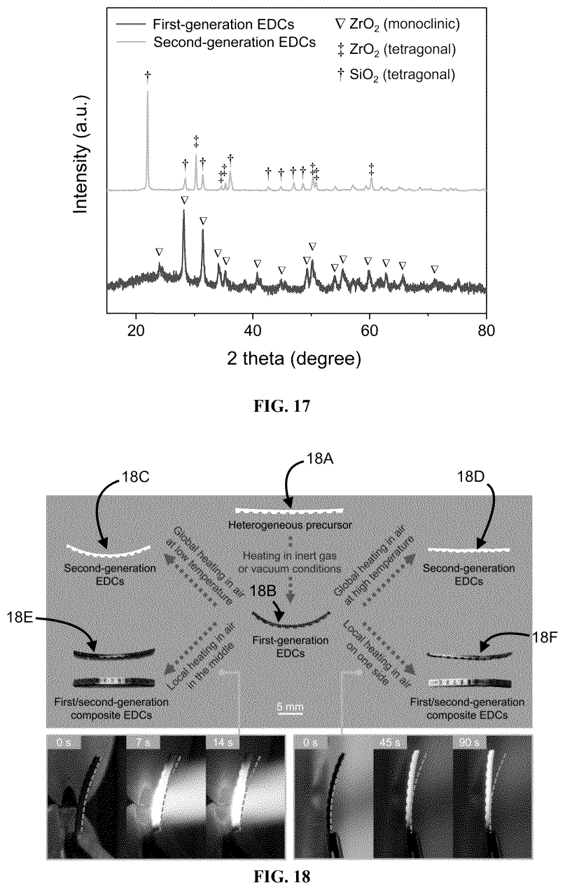

In FIGS. 13-15, the ceramics have an average composition of SiO_{1.65}C_{1.93}Zr_{0.07} and SiO_{2.04}C_{0.83}Zr_{0.04} for the first- and second-generation EDCs, respectively. And the first- and the second-generation EDCs have different crystal structures. FIG. 17 shows the X-ray diffraction analysis patterns of the crystal structures of the first- and second-generation EDCs. As shown, monoclinic zirconium dioxide ZrO₂ exists in the first-generation EDCs, while tetragonal zirconium dioxide ZrO₂ and silicon dioxide SiO₂ e exists in the second-generation EDCs.

In accordance with one embodiment of the present invention, a first/second-generation composite EDC can be generated through local heating in air, i.e., heating only a portion of a first-generation EDC in air. FIG. 18 illustrates such manufacturing process. As shown in FIG. 18, a structural precursor 18A is provided, and first-generation EDCs 18B are provided through heating the structural precursor 18A in inert gas or vacuum conditions.

By heating the entirety of the first-generation EDCs 18B, second-generation EDCs 18C, 18D with different curvatures are generated depending on the heating conditions. For example, the second-generation EDC 18C is formed through heating the first-generation EDC 18B with low temperature, and the second-generation EDC 18D is formed through heating the first-generation EDC 13B with high temperature. The curvature of the second-generation EDC 18C is different from the curvature of the second-generation EDC 18C. As such, the curvature of the SMCs is properly designed by controlling the heating temperature.

On the other hand, by local heating only portions of the first-generation EDCs 18B, the method produces SMCs with different shapes. For example, by heating only the middle portion of each of the first-generation EDCs 18B, first/second-generation composite EDCs 18E are generated; and by heating only one side of each of the first-generation EDCs 18B, first/second-generation composite EDCs 18F are generated. The shape of the second-generation composite EDCs 18E is different from the shape of the second-generation composite EDCs 18F. As such the shape of the first/second-generation composite EDCs 18E, 18F are properly designed.

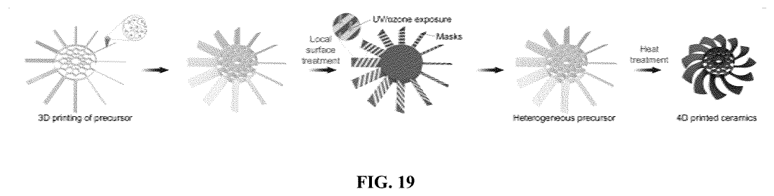

The ceramic 4D printing method according to the embodiments of the present invention can achieve geometrical flexibility and high morphing precision for advanced structural ceramics and can be used in high-temperature applications, such as aerospace propulsion. One derivative demonstration of the ceramic 4D printing method is illustrated in an exemplary application of the present invention with pictorial and image illustrations in FIGS. 19-21.

In this application, the ceramic engine turbine disk and 12 blades are 4D printed as a single piece and no assembly process was required. Through local UV/ozone exposure, blades with planar surfaces were simultaneously configured to achieve twisting deformation with high repeatability, resulting in a flower-like symmetrical structure.

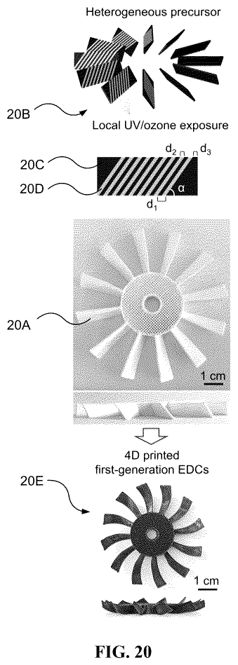

As shown in FIG. 20, a heterogeneous structural precursor 20A is provided, and the heterogeneous structural precursor 20A has 12 blades 20B, and every blade has a plurality of neutral portions 20C and UV/ozone treated portions 20D. The UV/ozone treated portions 20D form a plurality of strips among the neutral portions 20C with width d1 being 2 mm, width d2 being 1 mm, width d3 being 1.1 mm, and angle α being 55°. The angle α may range from 45° to 60°, and the widths d1, d2, and d3 can all be adjusted accordingly. The material of the heterogeneous structural precursor 20A comprises PDMS and zirconium dioxide with 20 weight percentage. By heating the heterogeneous structural precursor 20A, a ceramic blisk 20E (i.e., a turbomachine component comprising both rotor disk and blades as a single part) is produced. As such, an efficient single-piece 4D printing manufacturing method of engine turbine disk is provided without multi-component assembling.

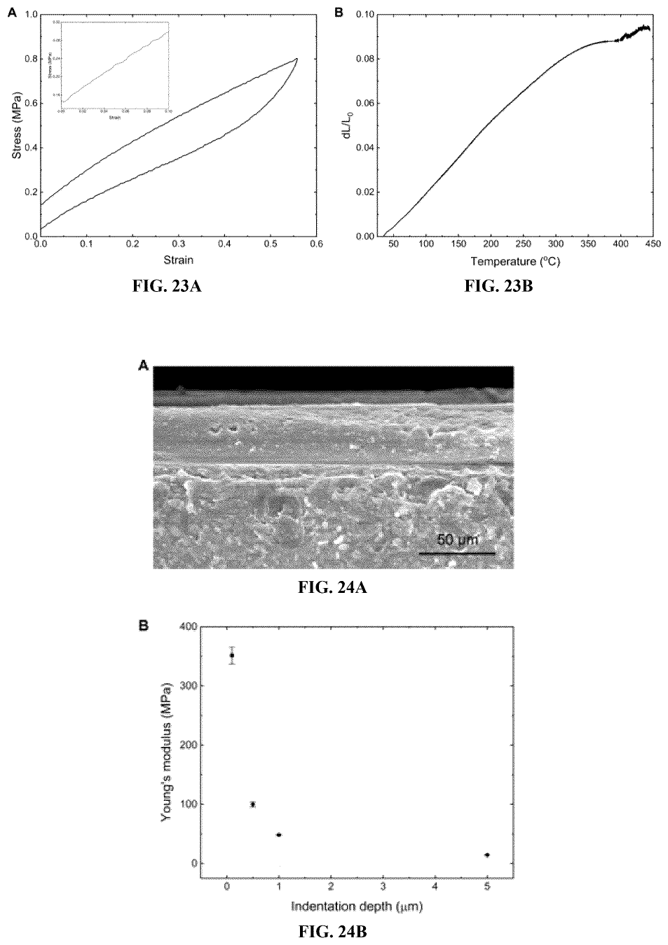

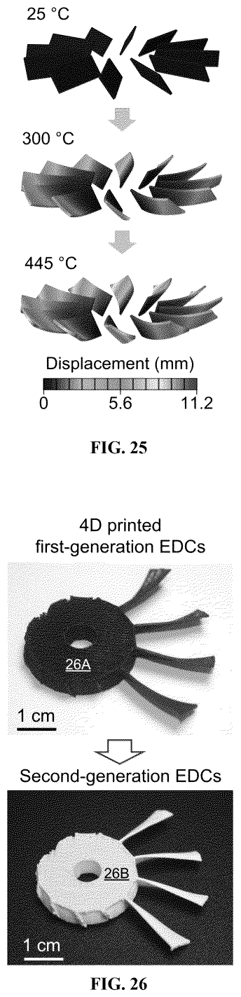

The high repeatability of the ceramic 4D printing method allows for high manufacturing precision in 3D structuring and 4D shaping. This high repeatability can be demonstrated by the 5 blades of a 4D printed all-ceramic blisk in another exemplary application of the present invention as illustrated in FIGS. 22A and 22B. The FEA simulation of the influence of thermal expansion on twisting deformation is consistent with the experimental results shown in FIGS. 23 to 25.

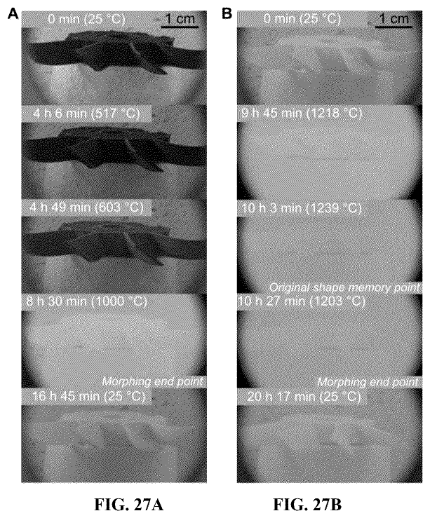

The shape memory behaviors can be demonstrated with a complicated all-ceramic bladed disk (blisk) structure in yet another exemplary application as shown in FIG. 26. In this exemplary application, the twisted blades in the first-generation EDCs can be tuned to the original planar shapes in the second-generation EDCs at an original shape memory point of 1,239° C. This is further illustrated in FIGS. 27A and 27B. FIG. 27A shows the shape and material transformations of first-generation EDCs derived from heterogeneous structural precursors for 4D printed all-ceramic blisk under heat treatment with a maximum temperature of 1,000° C. in air. FIG. 27B shows the shape and material transformations of the resultant ceramics as shown in FIG. 27A under heat treatment with a maximum temperature of 1,250° C. in air, resulting in the second-generation EDCs;

Therefore, the shape of the blades can be further adjusted through transforming the first-generation EDC to second-generation EDC. As shown in FIG. 26, the twisted blades of the first-generation EDC 26A can be transformed to different shapes and provide the second-generation EDC 26B through heat treatment on the first-generation EDC 26A.

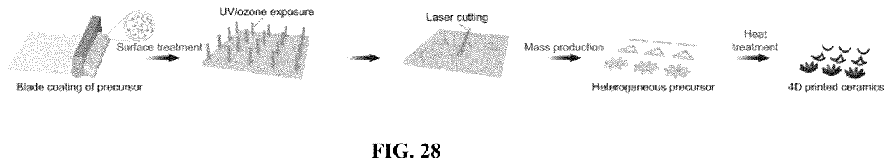

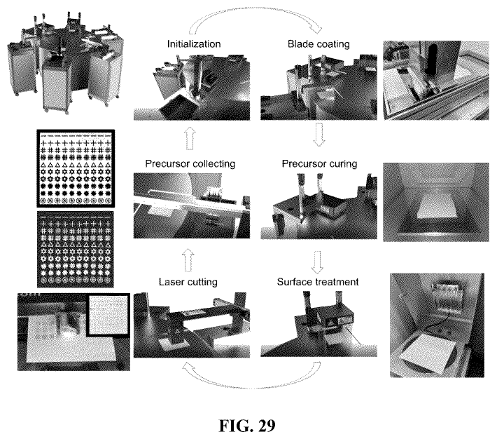

The industrialization potential of the embodiments of the present invention can be realized by the mass production capability of heterogeneous precursor materials assisted by a multistation turntable system. To enhance manufacturing speed, blade coating is implemented using an area-by-area printing strategy instead of DIW in the line-by-line printing strategy. The EPLC method and UV/ozone surface treatment ensure manufacturing precision for 3D structuring and 4D shaping, respectively. For example, as illustrated in FIGS. 28 to 30, the ceramic 4D printing method can be used to prepare a 10×10 array of heterogeneous precursors for ceramic kirigami structures with delicate features and high repeatability within 50 minutes, or 30 seconds per item on average.

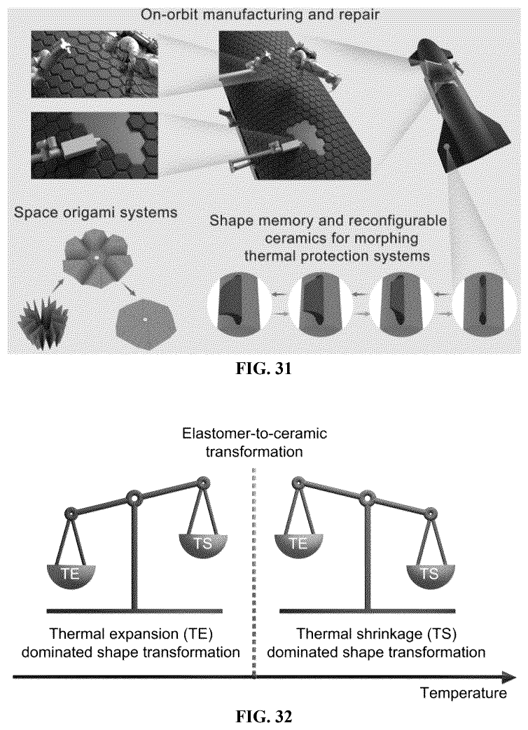

The present invention broadens the application scope of high-temperature structural materials in aerospace, electronics, biomedical, and art domains, among other fields. The 4D printing method according to the embodiments of the present invention can even be applied in space exploration, such as in morphing thermal protection systems as illustrated in FIG. 31. Specifically, 4D printed SMCs enhance the flexibility of the thermal protection system of a re-entry vehicle/capsule. Using real-time measured data, an optimized and reliable thermal protection system with shape-morphing capabilities can be 4D printed in situ to address the shape-related uncertainties and variable thermal environments encountered by reentry vehicles/capsules owing to various factors such as ablation and complex flow effects. The resulting lightweight design is preferable to the traditional design of heavy thermal shields as it can increase payload and reduce cost.

As illustrated in FIG. 31, the 4D printing method according to the embodiments of the present invention can be used in space for the on-orbit manufacturing of ultrahigh-performance turbine blades or on-orbit repair (such as additive remanufacturing) of heat shields and other essential parts that may fail in a long-term mission. The manufacture and repair based on the 4D printing method are more rapid and less expensive than traditional techniques, which require the prohibitively expensive placement of ultra-large-scale components in orbit or beyond.

The proposed ASM system according to the embodiments of the present invention can be used to realize rapid, precise, and scalable manufacturing of ceramic materials by increasing the 3D printing efficiency from line-by-line printing to area-by-area printing. The laser beam technique used in SM can be extended to other controlled high-energy flows such as electron beams, ion beams, high pressure liquids, and a combination of these. The framework involving UV/ozone films on elastomeric polymers can be extended to other 2D AM materials such as metal films to achieve heterogeneous precursors.

In summary, before the elastomer-to-ceramic transformation, the difference in the thermal expansion coefficients of the precursor materials resulted in a first-stage shape transformation. After the elastomer-to-ceramic transformation, the differences in the thermal shrinkage ratios of the precursor materials resulted in a second-stage shape transformation with notable material transformation. When the resultant first-generation EDCs were heated in air, the heterogeneity in the thermal shrinkage behavior of the first-generation EDCs resulted in original/reverse multimode shape memory behaviors and receramization into the second-generation EDCs. The balance between thermal expansion and shrinkage, thus is one of the key mechanisms for the 4D printing of ceramic materials, as illustrated in FIG. 32.

In various embodiments of the present invention, the development of SMCs starts from the martensitic phase transformation. The present invention introduces a completely new mechanism for fabricating SMCs that utilizes the heterogeneity in the thermal expansion-shrinkage behavior. Using the newly developed SMC fabrication mechanism, versatile SiOC-based SMCs can be developed in a facile manner by the physical mixing of liquid silicone with varying ceramic fillers. Geometrical flexibility is significantly enhanced with 4D ASM (2D/3D printing plus laser engraving/cutting of ceramic precursors) compared to i.e., the ceramic powder pressing used in the art. Furthermore, the dimensions of structural SMCs are extended from the microscale/mesoscale to the macroscale, achieving original/reverse and global/local multimode shape memory capabilities of ceramics. Thus, these aspects differentiate the present invention from existing manufacturing methods of SMCs. Table 1 below summarizes the differentiation of the present invention from previous works on SMCs.

TABLE 1

| Shape memory ceramics' | | | Flexibility of | Mechanism of |
|---|---|---|---|---|
| composition for material | Processing method for | Structural | shape memory | shape memory |
| universality | geometrical flexibility | dimensions | capability | ceramics |
| SiOC-based ceramics | 4D additive-substractive | macroscale | original/reverse, | heterogeneity in |
| derived from elastic | manufacturing | (over 4 cm) | global/local | thermal |
| precursors | (2D/3D printing + laser | | | expansion- |
| [this study] | engraving/cutting) | | | shrinkage behavior |
| (Zr/Hf)O₂(YNb)O₄ | ceramic powder | mesoscale | original, global | martensitic phase |
| [H. Gu et al. Nature | pressing | (4 mm) | | transformation |
| 2021, 599, 418] | | | | |
| ZrO₂-based ceramics | ceramic powder | microscale | original, global | martensitic phase |
| [A. Lal et al. Science | pressing + focused ion | (6 μm) | | transformation |
| 2013, 341, 1508] | beam | | | |

### EXPERIMENTS

The embodiments of the present invention were verified in experiments, and the experimental results are presented in the following.

### Preparation of Materials:

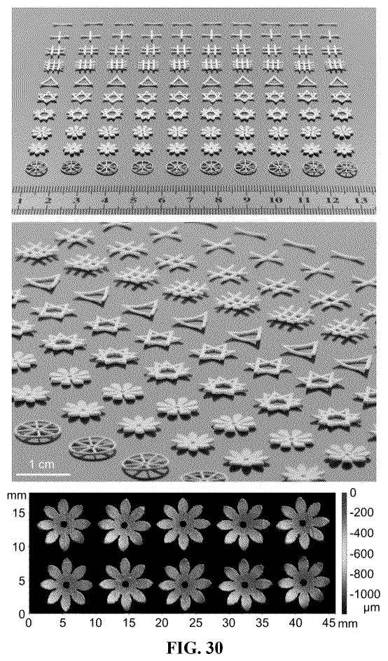

For the ceramic materials, the inks for the precursors shown in FIGS. 9, 13-16, 18, 20, 21, 26, 27A and 27B consisted of ZrO₂ nanoparticles (Tong Li Tech Co. Ltd.) and poly(dimethylsiloxane) (PDMS, SE1700, Dow Corning). Either 10 or 20 wt % ZrO₂ nanoparticles were added to the liquid PDMS and mixed using a triple roller mill (Exakt). The ink was then poured into a syringe and centrifuged. The ink for the precursors shown in FIG. 30 consisted of AlON nanoparticles (50 wt %) and PDMS (SE1700, Dow Corning). For the SiOC glass, liquid PDMS ink (SE1700, Dow Corning) was poured into a syringe and centrifuged.

### 4D ASM:

To realize the bending of heterogeneous ceramic precursors during the induction heating process, as shown in FIG. 9, solid precursors (22 mm×2 mm×0.8 mm) were 3D printed with PDMS/10 wt % ZrO₂ ink using a DIW machine (Regenovo Biotechnology Co., Ltd.). The printed precursors were then cured in an oven at 150° C. for 30 minutes. The cured precursors were laser-engraved to generate 11 evenly distributed grooves on the top surfaces using a CO₂ laser machining equipment (Epilog). The width of each groove was 1 mm, and their depths were 100, 200, 300, 400, and 500 μm. The samples were then flipped and subjected to UV/ozone treatment for 8 hours. The prepared heterogeneous ceramic precursors were heated to 1,300° C. within 12 minutes in an induction heating furnace with an argon flow of 200 mL min⁻¹ and maintained at this temperature for 10 minutes. To realize the shape memory behaviors, as shown in FIGS. 13-16, the first-generation EDCs derived from ceramic precursors with the groove depths of 100, 200, and 500 μm were then heated to 1,300° C. for 30 minutes in air with a tube furnace, resulting in second-generation EDCs.

To realize the global shape memory behaviors, as shown in FIGS. 27A and 27B, the first-generation EDCs derived from PDMS/10 wt % ZrO₂ were heated to 1,000° C. or 1,200° C. for 2 hours in air using a tube furnace. To realize the local shape memory behaviors, as shown in FIGS. 27A and 27B, the first-generation EDCs derived from PDMS/10 wt % ZrO₂ were locally heated to over 1,350° C. for 10 minutes in air in the middle or on one side of the sample with a flame gun. A superalloy mask with a round hole in the middle was used to perform local heat treatment in the middle of the sample.

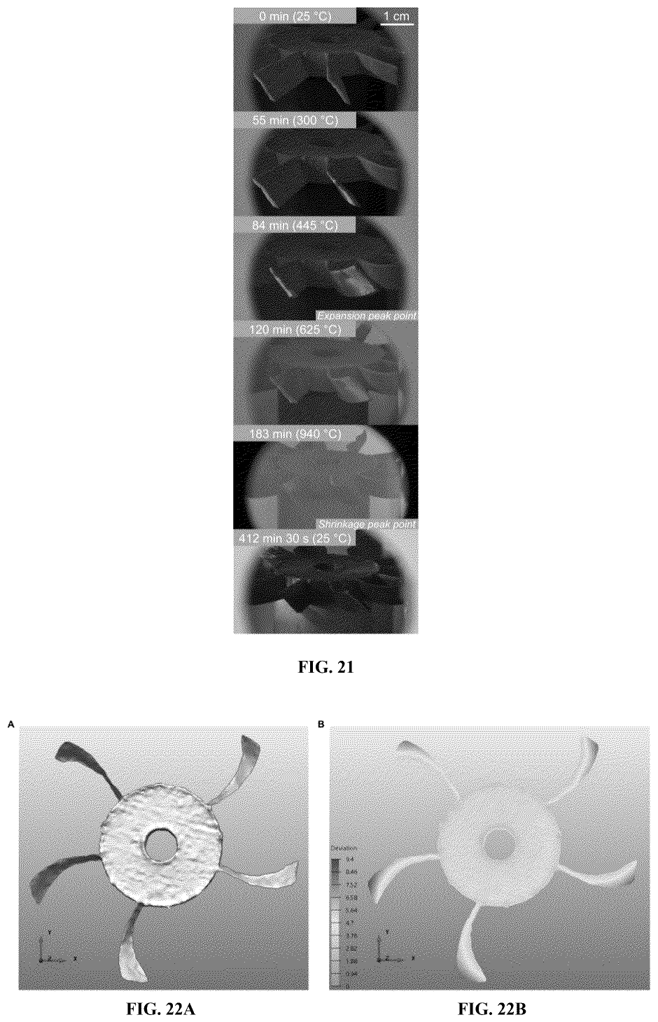

For the 4D printing and integrated shaping of the ceramic blisk, as shown in FIGS. 20 and 21, a sample of an engine turbine disk (inner and outer diameters of 10 mm and 32 mm, respectively) with 12 blades (24 mm×9 mm×0.9 mm) was 3D printed with the ink of PDMS/20 wt % ZrO₂. The surface of each blade is planar and intersects the ground at 57°. Each blade was then selectively exposed to UV/ozone treatment for 16 hours by masking the surface with laser-cut paper. The prepared heterogeneous ceramic precursors were heated to 1,000° C. for 2 hours, followed by cooling to ambient temperature under vacuum in a resistance heating furnace. The heating and cooling rates were 5° C. min⁻¹ and 10° C. min⁻¹, respectively. Afterwards, to realize the shape memory behaviors, as illustrated in FIGS. 26, 27A and 27B, the first-generation EDCs derived from heterogeneous precursors for 4D printed all-ceramic blisk were firstly heated at 1,000° C. and then at 1,250° C. in air using a tube furnace, resulting in second-generation EDCs.

To demonstrate the mass production capability of some embodiments, 2D AM of the ceramic precursor film (thickness: 0.5 mm) was conducted using a blade coating equipment. The precursor film was cured at 100° C. for 30 minutes and then 150° C. for 20 minutes. The surface of the precursor film was subjected to UV/ozone treatment for 50 minutes. Subsequently, the heterogeneous precursor was laser cut into a 10×10 array of designed structures within 4.5 minutes. All processing steps were controlled within 50 minutes, and with the assistance of a multistation turntable system, the mass production capability of heterogeneous precursor materials could be as efficient as 30 seconds per product, on average.

### Characterization:

Scanning electron microscopy analysis (SEM, Tescan Clara, Tescan; Nova-Nono430, FEI) was used to characterize the structures of the ceramics and UV/ozone films on the surfaces of the ceramic precursors. To characterize the porous feature inside EDCs, a pore size analyzer (BSD-PS(M), BeiShiDe Instrument) was used to obtain N₂ absorption-desorption isotherms of EDCs. Brunauer-Emmett-Teller analysis and nonlinear density functional theory was used to obtain specific surface area and pore size distribution of EDCs, respectively. A mercury intrusion porosimeter (MicroActive AutoPore V 9600, Micromeritics Instrument) was used to measure the porosity of the printed ceramic lattices. Optical profiler measurements (NPFLEX, Bruker) were obtained for mass-kirigami samples to determine the 3D morphology. Optical 3D scanning (ATOS Core 200, Abad Deghat Markazi Co.) was performed to quantify the repeatability of the blades of 4D printed all-ceramic blisk. Tension tests (Testpilot-10, Wance) of the precursors were performed using 3D printed solid samples (75 mm×10 mm×1 mm), at a displacement rate of 5 mm min⁻¹. Nanoindentation tests (Hysitron TI980, Bruker) were performed on the surface of the UV/ozone film to obtain the modulus for FEA simulation. Thermal expansion tests (DIL402C, NETZSCH) of the precursors were performed using 3D printed solid samples (20 mm×20 mm×4 mm) that were heated to 300° C. at a rate of 5° C. min⁻¹.

### Simulation:

FEA was performed using commercial software ABAQUS (2016) to examine the deformation behavior during thermal expansion. The UV/ozone film was modeled as an elastic shell. The precursor and UV/ozone film were assumed to be incompressible Neo-Hookean and elastic materials, respectively. The mechanical properties and dimensions of the structures were consistent with experimental measurements. The linear thermal expansion coefficients of PDMS/10 wt % ZrO₂ and PDMS/20 wt % ZrO₂, before the transformation to ceramics, were 283×10⁻⁶ and 242×10⁻⁶° C.⁻¹, respectively, according to the results of the thermal expansion tests. The moduli of PDMS/10 wt % ZrO₂ and PDMS/20 wt % ZrO₂ were set as 1.14 MPa and 1.56 MPa, respectively, according to the tension test results. During the loading process, a 0-10% strain was applied to obtain the corresponding Young's modulus. The thickness of the UV/ozone film exposed for 8 hours was set as 33 μm according to the SEM results, and its modulus was set as 13 MPa according to the nanoindentation results. The thickness of the UV/ozone film exposed on PDMS/20 wt % ZrO2 for 16 hours was set as 38 μm according to the SEM results, and its modulus was set as 20 MPa according to the nanoindentation results. The modulus of the equivalent film was calculated by assuming that the cross-sections had the same tensile stiffness. Before significant material transformation, the thermal expansion of the precursors dominated the shape transformation. Thus, only the thermal expansion was considered in the simulations.

The functional units and modules of the manufacturing and 4D printing methods of the SMCs in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or config. The computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A shape memory ceramic, comprising:
a first portion of the shape memory ceramic; and
a second portion of the shape memory ceramic;
wherein the first and second portions of the shape memory ceramic are bonded, and the shape memory ceramic is elastomer-derived ceramic comprising silicon oxycarbide; and
wherein the first portion of the shape memory ceramic is treated with ultraviolet ozone, and the second portion of the shape memory ceramic is free from treatment of ultraviolet ozone.

2. The shape memory ceramic of claim 1, wherein the second portion of the shape memory ceramic has one or more grooves.

3. The shape memory ceramic of claim 1, wherein the first portion of the shape memory ceramic form one or more strips on a surface of the second portion of the shape memory ceramic.

4. A manufacturing method of shape memory ceramic, comprising:
providing a structural precursor comprising polydimethylsiloxane (PDMS);
treating a portion of a surface of the structural precursor with ultraviolet ozone; and
processing the structural precursor using pyrolysis, so as to generate the shape memory ceramic.

5. The manufacturing method of claim 4, wherein the step of providing the structural precursor comprises:
forming a first precursor using additive manufacturing; and
cutting or engraving or polishing the first precursor using laser or mechanical tools to form the structural precursor.

6. The manufacturing method of claim 5, wherein the additive manufacturing comprises one or more of printing techniques; and
wherein the printing techniques comprise direct ink writing and blade coating.

7. The manufacturing method of claim 4, wherein the step of treating with ultraviolet ozone comprises:
masking a surface of the structural precursor; and
treating the masked surface with ultraviolet ozone.

8. The manufacturing method of claim 4, after the pyrolysis processing, further comprising:
heating the shape memory ceramic in air.

9. The manufacturing method of claim 4, after the pyrolysis processing, further comprising:
heating a portion of the shape memory ceramic in air.

10. The manufacturing method of claim 4, after the pyrolysis processing, further comprising:
heating at least a portion of the shape memory ceramic in air using a flame gun.

11. The manufacturing method of claim 4,
wherein the steps are performed in a turntable system with multiple stations, and every step is performed separately and in parallel manner in one of the stations for mass production of shape memory ceramics.

12. The manufacturing method of claim 4, wherein the structural precursor further comprises ceramic fillers or glass fillers.

13. A method of four dimensional (4D) printing of shape memory ceramics, the method comprising:
two/three dimensional (2D/3D) printing a structure of a material comprising an ink and a precursor;
treating the structure with ultraviolet ozone to create a heterogeneous precursor, wherein a treated portion of heterogeneous precursor has a different coefficient of thermal expansion or a different thermal shrinkage ratio from a remaining portion of the heterogeneous precursor;
heating the heterogeneous precursor, wherein a difference in the coefficient of thermal expansion or the thermal shrinkage ratio between the treated portion of the heterogeneous precursor and the remaining portion of the heterogeneous precursor creates an interface stress to cause a selected level of deformation, resulting in a first-generation ceramic; and
heating the first-generation ceramic, wherein heterogeneity in a thermal shrinkage or a thermal expansion behavior of the first-generation ceramic resulted in original/reverse multimode shape memory behaviors and receramization into a second-generation ceramic.

14. The method of claim 13, wherein the first-generation ceramic is reversibly reconfigurable to an original shapes of the heterogeneous precursor under appropriate heating conditions, resulting in a second-generation ceramic with original shape memory behavior.

15. The method of claim 14, wherein the second-generation ceramic with original shape memory behavior is further morphed in an opposite direction to a reverse morphed shape of the first-generation ceramic under appropriate heating conditions, resulting in a second-generation ceramic with reverse shape memory behavior.

16. The method of claim 13, wherein the heating of the first-generation ceramic is local and provides flexibility for local receramization and self-morphing of the first-generation ceramic, resulting in a first/second-generation composite ceramic with multiple shapes.

17. The method of claim 13, wherein the treating of the structure with ultraviolet ozone to create a heterogeneous precursor is global treating of the structure or local treating of the structure assisted with a mask.

18. The method of claim 13, further comprising removing a portion of the structure to create a shaped structure prior to or after the treating of the structure with ultraviolet ozone.

19. The method of claim 13, wherein the heating is performed by induction heating, resistance heating, or combinations thereof.

20. The method of claim 19, wherein the heating is performed in inert gas or vacuum conditions to obtain the first-generation ceramic, and in air to obtain the second-generation ceramic.

21. The method of claim 18, wherein the removal of a portion of the structure is by controlled laser beams.

22. The method of claim 18, wherein the removal of a portion of the structure is by engraving, cutting, polishing, or combination thereof.

23. The method of claim 18, wherein the removal of a portion of the structure is by electron beam, high pressure liquids, or other controlled high energy flow, or combinations thereof.

24. The method of claim 13, further comprising performing mass and rapid production of heterogeneous precursor materials using blade coating, laser cutting, or combination thereof.

25. The method of claim 24, wherein the performance of mass and rapid production of heterogeneous precursor materials is assisted by a multistation turntable system.

26. The method of claim 13, wherein the ink comprises polymers, or mixtures of polymers and particles; and
wherein the particles are selected from one or more of ceramic particles or glass particles.

27. The method of claim 13, wherein the precursor is selected from a poly(dimethylsiloxane), a polysiloxane, a polyborosiloxane, a polycarbosiloxane, a polysilazane or a poly(organosilylcarbodiimide), hydrogels, or combinations thereof.

28. The method of claim 26, wherein the ceramic particles are selected from one or more of zirconia (ZrO₂), Aluminum oxynitride (AlON), alumina (Al₂O₃), titania (TiO₂), silicon nitride (Si₃N₄), calcium oxide (CaO), silicon carbide (SiC), yttria (Y₂O₃), or aluminum nitride (AlN) particles.

29. The method of claim 13, wherein size of shape memory ceramics is of macroscale for engineering applications.

30. The method of claim 13, wherein the 2D/3D printing is selected from material extrusion (direct ink writing), blade coating, material jetting, photopolymerization, powder bed fusion, or combinations thereof.

31. The method of claim 13, further comprising physical vapor deposition, chemical vapor deposition, atomic layer deposition, or combinations thereof.

32. A shape memory ceramic for morphing thermal protection systems or space origami systems, wherein the shape memory ceramic is 4D printed by the method of claim 13.

33. A method for on-orbit manufacture and repair comprising the method of 4D printing of shape memory ceramics of claim 13.
